(19) United States
(12) Patent Application Publication
(10) Pub. No.: US 2013/0304483 A1
(43) Pub. Date: Nov. 14, 2013

(54) Method and System for Promoting a Pharmaceutical Product

(71) Applicant: David W. Cunningham, Raleigh, NC (US)

(72) Inventor: David W. Cunningham, Raleigh, NC (US)

(21) Appl. No.: 13/469,816

(22) Filed: May 11, 2012

(51) Int. Cl. G06Q 50/22

(52) U.S. Cl. 705/2

(57) ABSTRACT

A method implemented by a trusted third-party computing system assists a manufacturer of a prescription pharmaceutical product to promote that product by authorizing a pharmacy that makes one or more sales of the product to make one or more future purchases on promotional payment terms. The method includes receiving one or more electronic notifications that indicate the pharmacy has made one or more sales of the prescription pharmaceutical product to one or more patients, and then validating that the one or more indicated sales have actually occurred. Validation may entail validating data fields in each received notification and/or validating that the one or more sales are consistent with the pharmacy's inventory. Responsive to this validation, the method includes generating and sending control signalling based on the one or more indicated sales for triggering the manufacturer to authorize the pharmacy to make one or more future purchases on promotional payment terms.

### TECHNICAL FIELD

The present invention generally relates to the promotion of a prescription pharmaceutical product, and more particularly relates to a manufacturer of a pharmaceutical product promoting that product by authorizing a pharmacy that makes one or more sales of the product to make one or more future purchases on promotional payment terms.

### BACKGROUND

Manufacturers of prescription pharmaceutical products earnestly advertise and promote their products. Traditional forms of product promotion entail sending sales representatives to prescribers, providing free samples or trial products to prescribers, displaying advertisements in various media outlets, and the like. These traditional promotion tactics prove to have limited value, especially when generic product competition begins to mount, because the tactics focus almost exclusively on increasing product awareness, rather than on reducing product costs.

More recent forms of pharmaceutical product promotion tackle cost reduction in the face of rising competition. Manufacturers promote their products by offsetting a portion of the out-of-pocket expense (i.e., co-pay) that a patient must incur for the products. In doing so, manufacturers place their products in the same cost tier as their competition and effectively eliminate patient cost as a hurdle to gaining market share.

However, these most recent promotion tactics fail to address other hurdles that still remain. While the tactics address the cost incurred by patients, they neglect to address the cost that pharmacies and any wholesalers must incur to stock the products in inventory. Worse, any promotional tactic aiming to address this inventory carrying cost would prove complicated in the context of the pharmaceutical industry supply chain, where a long history of dealings between manufacturers, wholesalers, and pharmacies has fostered a business climate largely characterized by distrust between the parties.

### SUMMARY

Teachings herein advantageously enable a manufacturer of one or more prescription pharmaceutical products to promote those products by deferring at least some of the cost that pharmacies and any wholesalers incur to stock those products in inventory. The manufacturer implements this promotion by authorizing a pharmacy that makes one or more sales of the product to make one or more future purchases on promotional payment terms. That is, according to the promotion, the pharmacy's past sale of a promoted product authorizes the pharmacy to make a future purchase (e.g., of the promoted product, or of any product) on promotional payment terms. The manufacturer in some embodiments authorizes the pharmacy in this regard via a wholesaler, by authorizing the wholesaler to make one or more future purchases from the manufacturer on the promotional payment terms. The wholesaler then propagates the promotion to the pharmacy, by authorizing the pharmacy to make one or more future purchases from the wholesaler on the promotional payment terms.

Promotional payment terms as used herein comprise payment terms that are granted based on the sale of a certain pharmaceutical product being promoted by the manufacturer, as opposed to non-promotional payment terms that are granted apart from such a sale. In at least some embodiments, for instance, promotional payment terms comprise credit terms (e.g., net 90 days) that are extended in length as compared to non-promotional payment terms (e.g., net 30 days). Promotional payment terms thereby incentivize the sale of a certain promoted product in this example because the terms defer payment for a purchase (e.g., of the promoted product or of some other product) for longer than the non-promotional payment terms defer payment. Especially when products purchased with promotional payment terms are sold within the extended credit term, deferring payment in this way defers inventory carrying costs.

Broadly, embodiments herein thus include a method implemented by a computing system associated with the manufacturer for authorizing a pharmacy that makes one or more sales of the product to make one or more future purchases on promotional payment terms. Such processing includes receiving control signalling at the manufacturer computing system that indicates the pharmacy has made one or more sales of the prescription pharmaceutical product to one or more patients. Processing at the manufacturer computing system further includes determining an amount of one or more future purchases that the pharmacy is to be authorized to make on promotional payment terms, according to one or more rules defining that amount based on at least one of a product quantity and an amount associated with the one or more indicated sales. Finally, processing entails authorizing the pharmacy to make one or more future purchases for the determined amount on the promotional payment terms. In one or more embodiments, authorization in this regard is given to the pharmacy via a wholesaler from which the pharmacy purchased the promoted pharmaceutical product.

In some embodiments, distrust between the manufacturer and the pharmacy would preclude the manufacturer from offering the promotion to the pharmacy based solely on the pharmacy's self-serving indication that it has sold the manufacturer's products. In this case, the manufacturer computing system receives the control signalling from a trusted third-party computing system.

Thus, in these embodiments, processing at a trusted third-party computing system entails receiving one or more electronic notifications at the third-party computing system that indicate the pharmacy has made one or more sales of the prescription pharmaceutical product to one or more patients. Processing at the third-party computing system then includes validating that the one or more sales indicated by the one or more electronic notifications have actually occurred. Such validation may involve validating certain predefined data fields included in the one or more received notifications, validating that the one or more sales are consistent with the pharmacy's inventory, validating that a secondary payment claim has not been withdrawn within a predefined period of time, or the like. Regardless, responsive to this validation, processing at the third-party computing system includes vouching that the pharmacy is entitled to the promotion. More specifically, processing entails generating control signalling for triggering the manufacturer to authorize the pharmacy to make one or more future purchases on promotional payment terms and sending the generated control signalling from the third-party computing system, via one or more communication networks, to the manufacturer computing system.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram illustrating various computing systems communicatively coupled together for enabling a manufacturer of a prescription pharmaceutical product to promote that product, according to one or more embodiments.

FIG. 2 is a logic flow diagram of processing performed by a manufacturer computing system for promoting a prescription pharmaceutical product, according to some embodiments.

FIG. 3 illustrates a detailed example from a wholesaler's perspective of embodiments where a manufacturer authorizes a pharmacy that makes one or more sales of the product to make one or more future purchases on promotional payment terms.

FIG. 4 is a logic flow diagram of processing performed by a trusted third-party computing system for assisting a manufacturer of a prescription pharmaceutical product to promote that product, according to one or more embodiments.

FIG. 5 is a call flow diagram illustrating one or more embodiments where control signalling sent by a third-party computing system explicitly indicates that the third-party computing system has validated a sale's occurrence.

FIG. 6 is a call flow diagram illustrating one or more embodiments where control signalling sent by a third-party computing system explicitly indicates a pharmacy is authorized to make one or more future purchases on promotional payment terms for a certain amount.

FIG. 7 is a block diagram illustrating one or more embodiments where processing herein is performed by an accounting server in a manufacturer computing system and by a server in a trusted third-party computing system.

### DETAILED DESCRIPTION

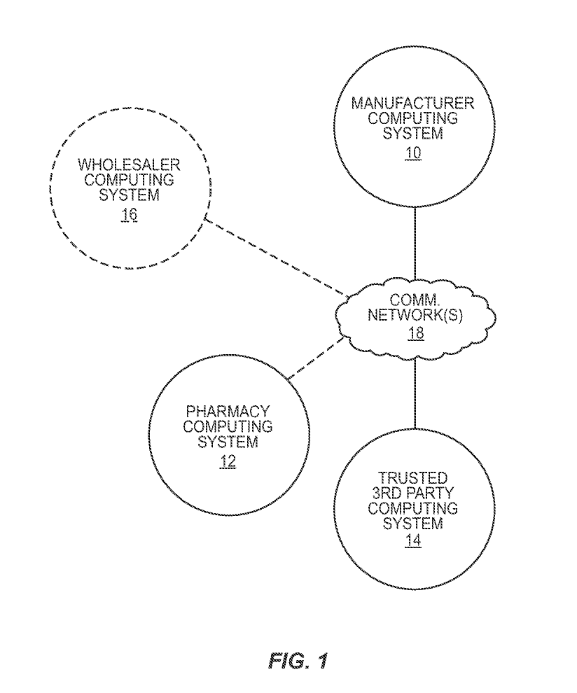

FIG. 1 illustrates computing systems that are communicatively coupled together via one or more communication networks 18 (e.g., a packet switched network such as the Internet). The computing systems include a computing system 10 associated with the manufacturer and a computing system 12 associated with a pharmacy. The computing systems may also include a computing system 14 associated with a third-party that is trusted by at least the manufacturer. In some embodiments, the computing systems further include a computing system 16 associated with a wholesaler via which the pharmacy purchases the manufacturer's pharmaceutical product.

The computing systems are communicatively coupled together in order to enable a manufacturer of a prescription pharmaceutical product to promote that product. The manufacturer promotes its product in this regard by authorizing a pharmacy that makes one or more sales of a promoted product to make one or more future purchases on promotional payment terms. That is, according to the promotion the pharmacy's past sale of a promoted product authorizes the pharmacy to make a future purchase (e.g., of the promoted product, or of any product) on promotional payment terms.

Promotional payment terms as used herein comprise payment terms that are granted based on the sale of a promoted pharmaceutical product, as opposed to non-promotional payment terms that are granted apart from such a sale. In general, promotional payment terms are more favorable than non-promotional payment terms in order to incentivize the sale of promoted products. In at least some embodiments, for instance, promotional payment terms comprise payment terms (e.g., net 90 days) that are extended in length as compared to non-promotional payment terms (e.g., net 10 days). Promotional payment terms thereby incentivize the sale of certain promoted products in this example because the terms defer payment for a purchase (e.g., of the promoted products or of some other product) for longer than the non-promotional payment terms defer payment. Especially when products purchased with promotional payment terms are sold within the extended payment term, deferring payment in this way defers inventory carrying costs, e.g., through working capital cash flow relief.

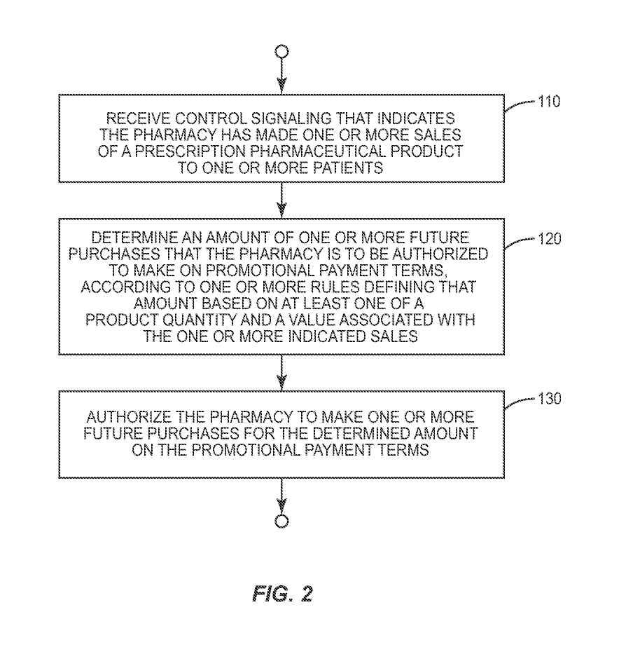

FIG. 2 shows details of the processing 100 performed by the manufacturer computing system 10 for granting promotional payment terms. As depicted in FIG. 2, such processing includes receiving control signalling at the manufacturer computing system 10 that indicates the pharmacy has made one or more sales of a prescription pharmaceutical product to one or more patients (Block 110). Responsive to this control signalling, processing at the manufacturer computing system 10 further includes determining an amount of one or more future purchases that the pharmacy is to be authorized to make on promotional payment terms, according to one or more rules defining that amount based on at least one of a product quantity and an amount associated with the one or more indicated sales (Block 120). The one or more rules may be provisioned in and retrieved from a computer-readable storage medium, such as an electronic database of products being promoted by the manufacturer.

As a simple example where the one or more rules define the amount of such future purchases based on a product quantity sold, the one or more rules define the amount C as being C=X·(P·Q), where P is a retrieved per-unit value associated with the product (e.g., the wholesaler acquisition cost of the product, in terms of defined product units), Q is the product quantity sold in terms of defined product units, and X is the percentage of a sale of a promoted product that contributes to the future purchase amount. In at least some embodiments, this percentage X is substantial (e.g., between 95% and 105%), meaning that the purchase amount computed is approximately equal to P·Q.

Regardless of the particular function used for this determination, processing further entails authorizing the pharmacy to make one or more future purchases for the determined amount on the promotional payment terms (Block 130). In one or more embodiments, the pharmacy is authorized to make these one or more future purchases via a wholesaler from which the pharmacy purchased the product. Moreover, in at least some embodiments, the determined amount may be applied towards the future purchase of any of the manufacturer's products, not just the promoted product whose sale authorized the promotional payment terms.

In some embodiments the manufacturer authorizes the pharmacy to make the one or more future purchases directly from the manufacturer. In other embodiments, by contrast, the manufacturer authorizes the pharmacy to make the one or more future purchases from the manufacturer via a wholesaler from which the pharmacy purchased the promoted product. In this case, the manufacturer authorizes this wholesaler to make one or more future purchases from the manufacturer for the determined amount on the promotional payment terms, and the wholesaler propagates the promotion to the pharmacy by authorizing the pharmacy to make one or more future purchases from the wholesaler for the determined amount on the promotional payment terms. In some embodiments, the manufacturer computing system 10 extracts an identity of the wholesaler from an explicit data field in the received control signalling. In other embodiments, though, the manufacturer computing system 10 maps identifiers of the pharmacy and/or product to the wholesaler identity by referencing a database that maps different pharmacies and/or products to different wholesalers.

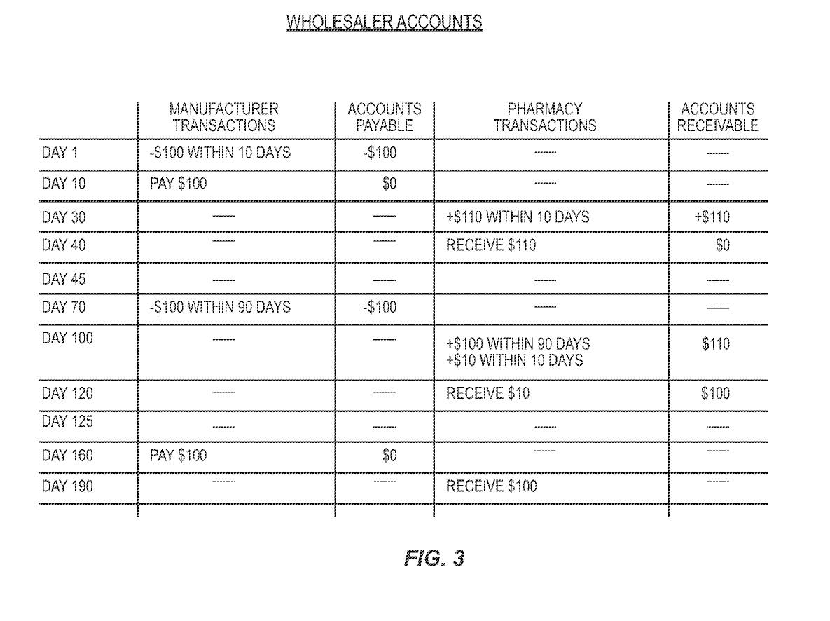

FIG. 3 details a simple example from the perspective of a wholesaler in order to demonstrate these embodiments. As shown in FIG. 3, a wholesaler has previously sent the manufacturer a purchase order for 100 units (e.g., pills) of a promoted product at a cost of $100. The manufacturer fulfils the order and sends the wholesaler a corresponding invoice for the order on Day 1. The payment terms associated with this invoice are non-promotional and specify that the wholesaler owes the manufacturer the $100 purchase price within 10 days (i.e., by Day 10) of the invoice's issuance. Thus, on Day 1, the wholesaler has an accounts payable with respect to the manufacturer of $100.

Thereafter, on Day 10, the wholesaler pays the manufacturer the $100 purchase price, even though the wholesaler has not yet sold the 100 units of the promoted product to the pharmacy. The wholesaler thus has an accounts payable on Day 10 of $0. It is not until later that the wholesaler receives a purchase order from the pharmacy for 100 units of the promoted product. In response to the pharmacy's purchase order, the wholesaler fulfils the order and sends the pharmacy an invoice for the order on Day 30, meaning that the wholesaler held the 100 units of the product in inventory for 20 days after having paid for those units. Nonetheless, the wholesaler's invoice reflects that the wholesaler sold the 100 units of the promoted product to the pharmacy with a $10 mark-up, at a price of $110. The invoice also reflects that the wholesaler sold the 100 units of the promoted product on non-promotional payment terms requiring payment of the full $110 purchase price within 10 days of the invoice's issuance (i.e., within 10 days of Day 30).

Within 10 days of the invoice's issuance, though, i.e., on Day 40, the pharmacy has not sold the 100 units of the promoted product to a patient. Despite this, the pharmacy still has to pay the wholesaler the full $110 on Day 40 according to the non-promotional payment terms. A few days later, on Day 45, the pharmacy sells 100 units of the product to a patient. The non-promotional payment terms (net 10 days) on which the product was purchased, therefore, caused the wholesaler to hold the 100 units of the product in inventory for 20 days after having paid for those units and caused the pharmacy to hold the units in inventory for 5 days after having paid for them.

Notably, though, the pharmacy's sale of 100 units of the promoted product to the patient causes the manufacturer to authorize the pharmacy (via the wholesaler) to make a future purchase of $100 (which is 100 units×the $1/unit wholesaler acquisition cost of the promoted product) on promotional payment terms of net 90 days rather than the non-promotional payment terms of net 10 days. Specifically, the manufacturer receives control signalling indicating that the pharmacy sold 100 units of the promoted product to the patient. Responsive to this control signalling, the manufacturer determines that the pharmacy (via the wholesaler) is to be authorized for $100 in one or more future purchases on promotional payment terms of net 90, according to one or more rules defining that amount based on the quantity of the product sold by the pharmacy and the wholesaler's acquisition cost (in per-unit terms). Having made this determination, the manufacturer authorizes the wholesaler to issue a purchase order for $100 of any of the manufacturer's products according to the net 90 promotional payment terms. The wholesaler propagates this authorization to the pharmacy, authorizing the pharmacy to issue a purchase order for $100 of any of the wholesaler's products according to the net 90 promotional payment terms.

In accordance with this authorization, the wholesaler later issues a purchase order to the manufacturer for $100 of one of the manufacturer's products on net 90 promotional payment terms. The manufacturer fulfils the order and sends the wholesaler a corresponding invoice for the order on Day 70. The payment terms associated with this invoice are promotional and specify that the wholesaler owes the manufacturer the $100 purchase price within 90 days of the invoice's issuance, meaning that the wholesaler does not owe the manufacturer the $100 until Day 160 rather than Day 80 as would have been the case according to the non-promotional payment terms.

Thereafter, the wholesaler receives a purchase order from the pharmacy in accordance with the authorization that the wholesaler propagated to the pharmacy. In this example, the purchase order is for the same quantity of the promoted product as before (100 units), and the wholesaler still charges the pharmacy $110 for this product. The wholesaler fulfils the order and sends the pharmacy an invoice for the order on Day 100. However, since the wholesaler only authorized $100 in future purchases on net 90 promotional payment terms, the wholesaler issues the invoice to indicate that $100 of the purchase is on the net 90 promotional terms but that the remaining $10 of the purchase remains on the net 10 non-promotional terms. Thus, the pharmacy will owe the wholesaler $10 within 10 days of the invoice's date, on Day 120, and $100 within 90 days of the invoice's date, on Day 190.

Both the wholesaler and the pharmacy benefit from the manufacturer's promotion through deferral of inventory carrying costs. The wholesaler benefits from the manufacturer's promotion because, rather than having to pay for the product on Day 80 (20 days before issuing an invoice to the pharmacy), the wholesaler defers payment until Day 160 (60 days after issuing an invoice to the pharmacy). Assuming the pharmacy sells the product to a patient on Day 125, the pharmacy realizes an analogous benefit. With the wholesaler propagating the promotional payment terms, the pharmacy no longer owes the manufacturer the full $110 purchase price on Day 120 (10 days after receiving an invoice from the wholesaler). Instead, the pharmacy on Day 120 only owes the wholesaler the difference between the amount applicable to the promotional payment terms and the $110 purchase price, which is $10 in this example. The remaining $100 does not become due for the pharmacy until Day 190, meaning that the pharmacy advantageously defers inventory carrying costs when it sells the promoted product.

Note that while the above description generally described promotional payment terms being authorized upon the sale of a particular one of a manufacturer's products, this need not be the case. In fact, in at least some embodiments, the manufacturer computing system 10 selectively authorizes promotional payment terms responsive to the sale of a subset of its products by a subset of pharmacies, in order to selectively promote those certain products to those certain pharmacies. The manufacturer computing system 10 may also selectively authorize promotional payment terms for sales occurring during certain defined periods of time. In general, therefore, the manufacturer computing system 10 may enforce any number of defined conditions for the sale of a prescription pharmaceutical product to entitle a pharmacy to promotional payment terms.

In this case, the manufacturer computing system 10 is configured to obtain one or more rules defining such conditions, such as retrieving them from a computer-readable storage medium. The manufacturer computing system 10 may then verify that the sale indicated by the received signalling meets the defined conditions, before selectively authorizing promotional payment terms based on the sale. As suggested above, some of these conditions may include the pharmacy being included in a defined list of pharmacies eligible for promotional payment terms, the sold product being included in a defined list of products being promoted with promotional payment terms for one or more future purchases, and the sale being made within a defined time period. Of course, although the authorization of promotional payment terms may only be triggered by the sale of select ones of the manufacturer's products, the promotional payment terms themselves may still be applied to the future purchase of any products.

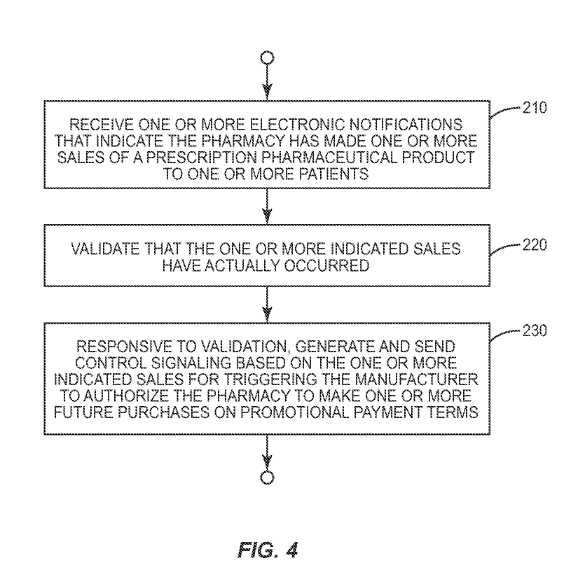

In some embodiments, distrust between the manufacturer and the pharmacy would preclude the manufacturer from offering the promotion to the pharmacy based solely on the pharmacy's self-serving indication that it has sold the manufacturer's products. In this case, the manufacturer computing system 10 receives the control signalling from the trusted third-party computing system 14. FIG. 4 illustrates details of processing 200 performed by the third-party computing system 14 in this regard.

As depicted in FIG. 4, such processing includes receiving one or more electronic notifications at the third-party computing system 14 that indicate the pharmacy has made one or more sales of the prescription pharmaceutical product to one or more patients (Block 210). This may entail the third-party computing system 14 inspecting each received notification and extracting identifiers for the pharmacy, product, and quantity from predefined data fields known to specify those identifiers.

In at least some embodiments, the third-party computing system 14 receives these one or more electronic notifications from a computing system associated with a prescription claim processor that processes secondary payment claims for the one or more sales of the product. Secondary payment claims in this regard contrast with primary payment claims. A pharmacy makes a primary payment claim for the one or more sales of the product before making a secondary payment claim for those sales, meaning that the secondary payment claim accounts for the results of the primary payment claim.

Regardless of how the third-party computing system 14 receives the notifications, processing at the third-party computing system 14 then includes validating that the one or more sales indicated by the one or more notifications have actually occurred (Block 220). Such validation may involve validating one or more data fields in each notification that include information about the respectively indicated sale. In this case, validation entails extracting such data fields from the electronic notification and retrieving from a computer-readable storage medium (e.g., an electronic database) one or more rules defining valid entries for those data fields. Validation then includes validating the extracted data fields against the retrieved rules.

In some embodiments, information that is characteristic of an actual sale and that is therefore appropriately validated by the third-party computing system 14 includes, for instance, a code or other identifier for the sold product (e.g., a national drug code), the quantity of the product sold, the number of days over which such a quantity is to be taken by the patient (i.e., the number of days supplied), and/or the date and time of the sale. Other information to be validated includes in at least one embodiment the name of the patient who purchased the product, an identifier of the pharmacy that sold the product, and/or a prescription number. In still other embodiments, the information to be validated includes a signature of the patient as obtained by the pharmacy when the patient picked up the sold product.

In one or more embodiments, rules defining valid entries for these data fields simply specify a particular format for the fields, including for instance a minimum and/or maximum character length. In other embodiments, these rules further validate the existence of or even authenticity of a patient's signature obtained at the time the sold product was picked up. Moreover, the rules in some embodiments validate that any given data field contains one of a plurality of valid possibilities for the field. For example, the rules limit a data field for product quantity to being valid only if the field contains one of a plurality of defined possibilities (e.g., associated with the quantities in which the manufacturer distributes the product or in which a wholesaler sells the product to pharmacies). Still further, the rules validate in at least one embodiment that the current sale does not conflict with previous sales. For instance, the rules validate that a current sale of a particular product to a particular patient has not been made within a predetermined time period since a previous sale of that same product (or one with similar active ingredients) to that same patient. In this case, the third-party computing system 14 computes this predetermined time period as a function of the “days supply” associated with the previous sale.

Validation extends further in at least some embodiments where the one or more electronic notifications are received from a prescription claim processor. In these embodiments, a sale indicated by a received notification is validated as having actually occurred if a secondary payment claim for that sale has not been withdrawn within a predetermined period of time. Specifically, the third-party computing system 14 receives one or more notifications from the prescription claim processor identifying one or more secondary payment claims that have been withdrawn.

A secondary payment claim is subject to being withdrawn if the pharmacy makes the claim before the patient has picked up the product and otherwise completed the sale. Conventionally, if the patient fails to pay for and pick up the product within a predetermined period of time (e.g., 14 days), then the pharmacy withdraws or otherwise disposes of the claim. Thus, in this case, the third-party computing system 14 validates that a sale has actually occurred if a secondary payment claim has not been withdrawn within a predetermined period of time.

Actual implementation of the above embodiments may entail the third-party computing system 14 delaying validation of a sale and triggering of promotional payment term authorization until the predetermined period of time has passed. Otherwise, the third-party computing system 14 may retroactively trigger a reversal of promotional payment terms that have been previously authorized, once the system 14 obtains information about the claim being withdrawn.

Validation of an indicated sale in other embodiments further extends to validating that the sale is consistent with the pharmacy's inventory. More specifically, processing at the third-party computing system 14 entails electronically tracking quantities of the pharmaceutical product purchased by the pharmacy. With the inventory of the pharmacy tracked in this way, the third-party computing system 14 validates the one or more indicated sales only if the quantity of the pharmaceutical product sold by the pharmacy, including the one or more indicated sales of the product, is no greater than a quantity threshold defined based on the quantity purchased. In some embodiments, this quantity threshold is defined as a certain margin or percentage above the tracked quantity of the product purchased. Defining the threshold in this way proves advantageous to build in cushions that account for intentional or unintentional delays in inventory tracking.

In some embodiments, this inventory tracking entails the third-party computing system 14 receiving electronic inventory updates and/or sales notifications from the pharmacy computing system 12, the wholesaler computing system 16, and/or the manufacturer computing system 10. In one embodiment, for example, the third-party computing system 14 receives sale trace information from the manufacturer computing system 10 that traces sales of the promoted product from the manufacturer into the pharmacy (e.g., via a wholesaler). The sales trace information therefore indicates the supply of the product into the pharmacy. In this case, the third-party computing system 10 validates the one or more indicated sales by reconciling those sales against the sales trace information, e.g., to verify that the pharmacy is not indicating it has sold a greater quantity of the promoted product than the quantity of the promoted product supplied to the pharmacy.

Responsive to validating the sale's occurrence, regardless of the particular approach used for such validation, processing at the third-party computing system 14 includes vouching that the pharmacy is entitled to the promotion based on the indicated sale(s); that is, vouching for the pharmacy to be authorized to make one or more future purchases on promotional payment terms. This specifically entails generating control signalling for triggering the manufacturer to authorize the pharmacy to make one or more future purchases on promotional payment terms and sending the generated control signalling from the third-party computing system 14, via the one or more communication networks 18, to the manufacturer computing system 10 (Block 230).

The specific control signalling generated by the third-party computing system 14 may vary between different embodiments in terms of what it indicates. But, in general, the control signalling triggers the manufacturer's authorization because it ultimately demonstrates to the manufacturer computing system 10 that the third-party computing system 14 has validated the one or more indicated sales' occurrences and thus vouches for the pharmacy's entitlement to the promotion.

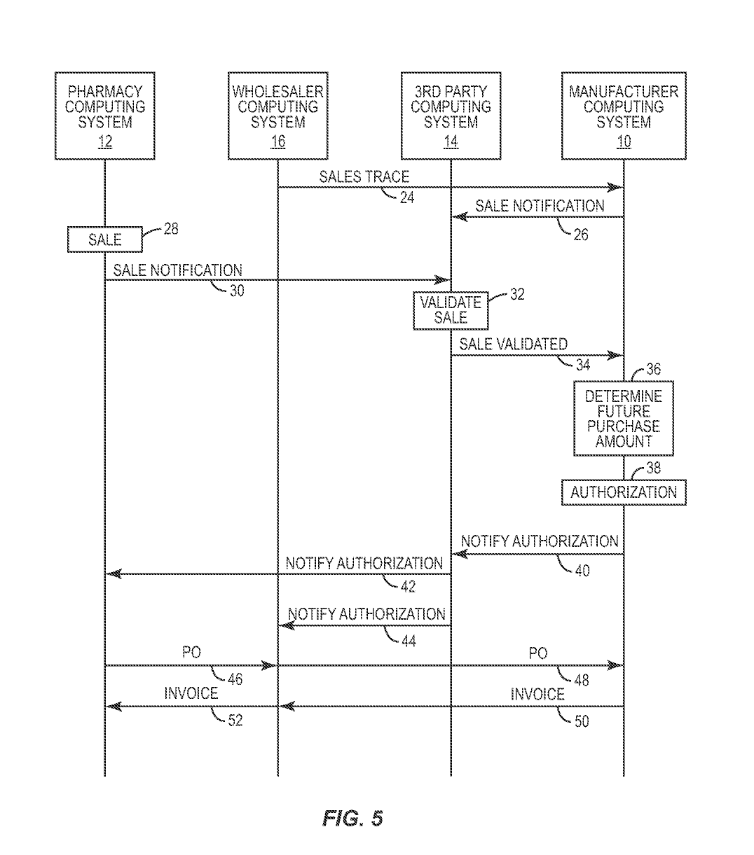

FIG. 5, for example, illustrates one or more embodiments where the control signalling explicitly indicates that the third-party computing system 14 has validated the one or more sales' occurrence. In order to also illustrate other variations and modifications to the embodiments herein, FIG. 5 illustrates these control signalling embodiments in a context where a particular pharmacy purchases the product from the manufacturer via a wholesaler.

As shown in FIG. 5, the wholesaler computing system 16 occasionally or periodically sends the manufacturer computing system 10 sales trace information 24 as described above. Based on this sales trace information 24, the manufacturer computing system 10 in turn occasionally or periodically sends sales notifications 26 to the third-party computing system 14. With such notifications the third-party computing system 14 electronically tracks quantities of the manufacturer's product that have been purchased by the pharmacy, in order to later validate sales indicated by the pharmacy. In this regard, after the pharmacy computing system 12 processes one or more sales of a pharmaceutical product (Block 28), the system 12 sends one or more electronic notifications 30 indicating those sales to the third-party computing system 14. A notification 30 may include any number of details about a sale, including for instance information specifying the particular pharmacy that has made the sale, the particular product sold, and the amount of the sold product (e.g., in terms of a quantity or dollar value associated with the sale(s)). Information specifying the particular manufacturer associated with the sold product may be indicated by the notification 30 either explicitly or implicitly based on the information specifying the sold product.

Having received these one or more electronic notifications 30, the third-party computing system 14 validates that the one or more sales indicated by the one or more notifications 30 has actually occurred (Block 32). This validation may be accomplished in any of the ways described above, such as based sales notifications 26 previously received, and may be performed either periodically (e.g., every 2 weeks) for groups of sales notifications or on a notification-by-notification basis. In any case, responsive to this validation, the third-party computing system 14 generates control signalling 34 explicitly or implicitly indicating that the one or more sales' occurrence has been validated by the third-party computing system 14.

The control signalling 34 in some embodiments for instance includes one or more data fields dedicated to explicitly indicate this validation. The control signalling 34 in other embodiments indicates an amount (e.g., a retail dollar value) of the one or more sales made by the pharmacy and/or simply a quantity of the product sold in connection with the one or more indicated sales. Alternatively, the third-party computing system 14 in other embodiments generates the control signalling 34 to be similar to an electronic notification 30 received from the pharmacy computing system 12, except for having been cryptographically signed by the third-party computing system 14 using public key cryptography, secret key cryptography, or the like. For example, the third-party computing system 14 cryptographically signs a received notification 30 with the private key of a public-private key pairing. The manufacturer computing system 10 then verifies the private key signature of the control signalling 34 with the corresponding public key. Regardless of the particular implementation, this cryptographic signature implicitly certifies to the manufacturer computing system 10 that the one or more indicated sales have been validated by the third-party computing system 14, while at the same time cryptographically verifies the integrity of the control signalling 34 to the manufacturer computing system 10. In addition, the third-party computing system 14 may cryptographically authenticate its identity to the manufacturer computing system 10 prior to or in conjunction with sending the control signalling 34.

Irrespective of the particular way in which the control signalling 34 indicates that the one or more sales 28 have been validated, this validation effectively operates as a third-party voucher for the manufacturer to authorize the pharmacy, via the wholesaler, to make one or more future purchases on the promotional payment terms and thereby triggers the manufacturer computing system 10 to grant that authorization. This trigger may of course be further conditioned on other validations that the manufacturer computing system 10 makes itself, such as validations previously mentioned with respect to the promotion of only select products sold by select pharmacies. But, provided that authorization is triggered, the manufacturer computing system 10 computes or otherwise determines an amount of one or more future purchases that the pharmacy is to be authorized to make on promotional payment terms via the wholesaler (i.e., an amount of product that may be purchased in the future on the promotional payment terms) (Block 36). Such may entail retrieving a predefined per-unit value associated with the product from a computer-readable storage medium (e.g., a database) and computing the amount based on one or more rules defining that amount as a function of the retrieved value and the quantity of product sold. The manufacturer computing system 10 then actually authorizes the pharmacy, via the wholesaler, to make one or more future purchases for the determined amount on the promotional payment terms (Block 38).

As shown, the manufacturer computing system 10 authorizes the pharmacy to make the one or more future purchases from the manufacturer via a wholesaler from which the pharmacy purchased the promoted product. In this regard, the sale notification 30 and/or the control signalling 34 may have been generated to explicitly indicate such a wholesaler to the manufacturer computing system 10. Alternatively, the manufacturer computing system 10 may be configured with an electronic database that identifies via which wholesaler certain pharmacies purchase certain products.

Regardless, the manufacturer computing system 10 sends an electronic notification 40 to the third-party computing system 14 indicating that the manufacturer has in fact authorized the pharmacy to make one or more future purchases for the determined amount on the promotional payment terms via the wholesaler. The third-party computing system 14 correspondingly sends this notification of authorization to the pharmacy computing system 12 and the wholesaler computing system 16, by sending electronic notifications 42, 44 to those systems 12, 16. These notifications 42, 44 effectively authorize the pharmacy and the wholesaler to issue a purchase order for the determined purchase amount according to the promotional payment terms. After receiving these notifications, the pharmacy computing system 12 issues such a purchase order (PO) 46 to the wholesaler computing system 16 and the wholesaler computer system 16 issues such a purchase order 48 to the manufacturer computing system 10. Upon fulfilling the purchase order 48 from the wholesaler computing system 16, the manufacturer computing system 10 issues a corresponding invoice 50. Similarly, upon fulfilling the purchase order 46 from the pharmacy computing system 12, the wholesaler computing system 16 issues a corresponding invoice 52.

In at least some embodiments, the third-party computing system 14 is configured to receive a notification 40 from the manufacturer computing system 10 indicating an amount of one or more future purchases that the pharmacy is to be authorized to make on promotional payment terms. In this case, the third-party computing system 14 includes this amount in the electronic notifications 42, 44 that it sends to the pharmacy computing system 12 and the wholesaler computing system 16.

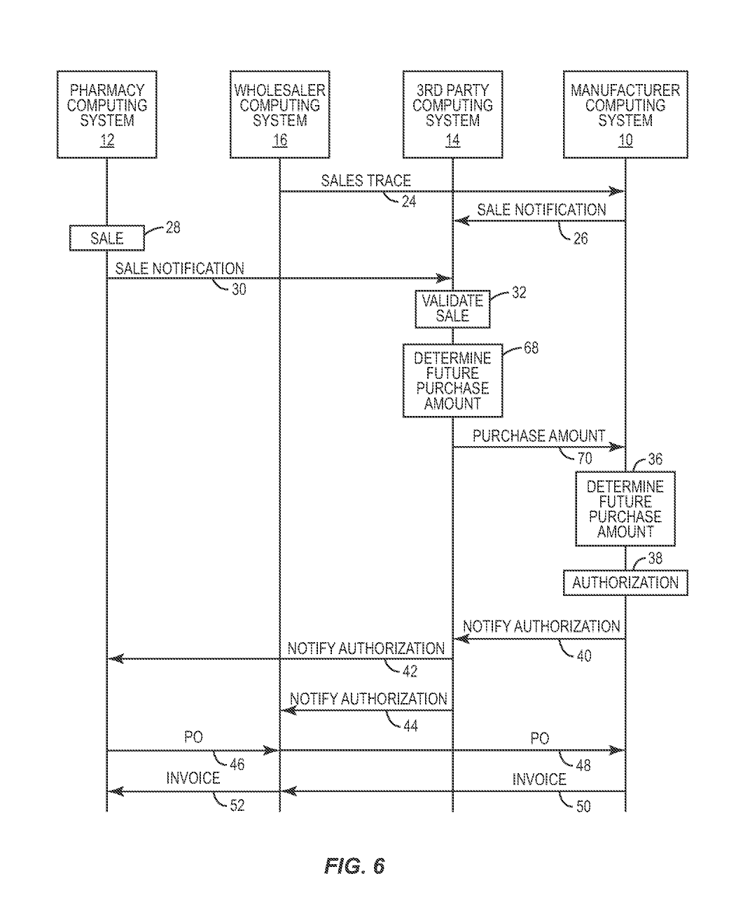

FIG. 6 illustrates a variation of the above embodiments. Specifically, FIG. 6 depicts a variation whereby the third-party computing system 14 sends authorization-triggering control signalling to the manufacturer computing system 10 that explicitly indicates the pharmacy is entitled to make one or more future purchases on the promotional payment terms. Thus, the third-party computing system 14 operates more as a moderator of the promotion, rather than just a validator of pharmacy sales.

In at least some embodiments, for example, the third-party computing system 14 is configured to selectively moderate the conditions for a pharmacy to be entitled to promotional payment terms, without moderating the particular amount to which those terms are to apply. In this case, the third-party computing system 14 is configured to obtain one or more rules, such as by retrieving them from a computer-readable storage medium. These obtained rules define conditions for one or more sales of a prescription pharmaceutical product to entitle a pharmacy to promotional payment terms. As suggested above, some of these conditions may include the pharmacy being included in a defined list of pharmacies eligible for promotional payment terms, the sold product being included in a defined list of products being promoted with promotional payment terms for one or more future purchases, and the sale being made within a defined time period. Regardless, the third-party computing system 14 then verifies that the one or more sales indicated by the received notification 30 meets the defined conditions, before selectively generating and sending control signalling to the manufacturer computing system 10 indicating the pharmacy is entitled to make one or more future purchases on promotional payment terms.

In other embodiments, and as shown in FIG. 6, the third-party computing system 14 also moderates the particular amount of one or more future purchases that the pharmacy is to be authorized to make on promotional payment terms. Specifically, FIG. 6 depicts that the third-party computing system 14 computes or otherwise determines this future purchase amount, responsive to validating occurrence of the one or more sales indicated by the one or more received notifications 30 (Block 68). Similar to the manufacturer's computation in FIG. 5, the third-party computing system 14 may compute this amount by retrieving a predefined per-unit value associated with the product from a computer-readable storage medium (e.g., a database) and computing the amount based on one or more rules defining that amount as a function of the retrieved value and the quantity of product sold. The third-party computing system 14 then sends control signalling 70 to the manufacturer computing system 10 that indicates the computed amount and that triggers the manufacturer computing system 10 to authorize the pharmacy to make one or more future purchases for the computed amount on the promotional payment terms.

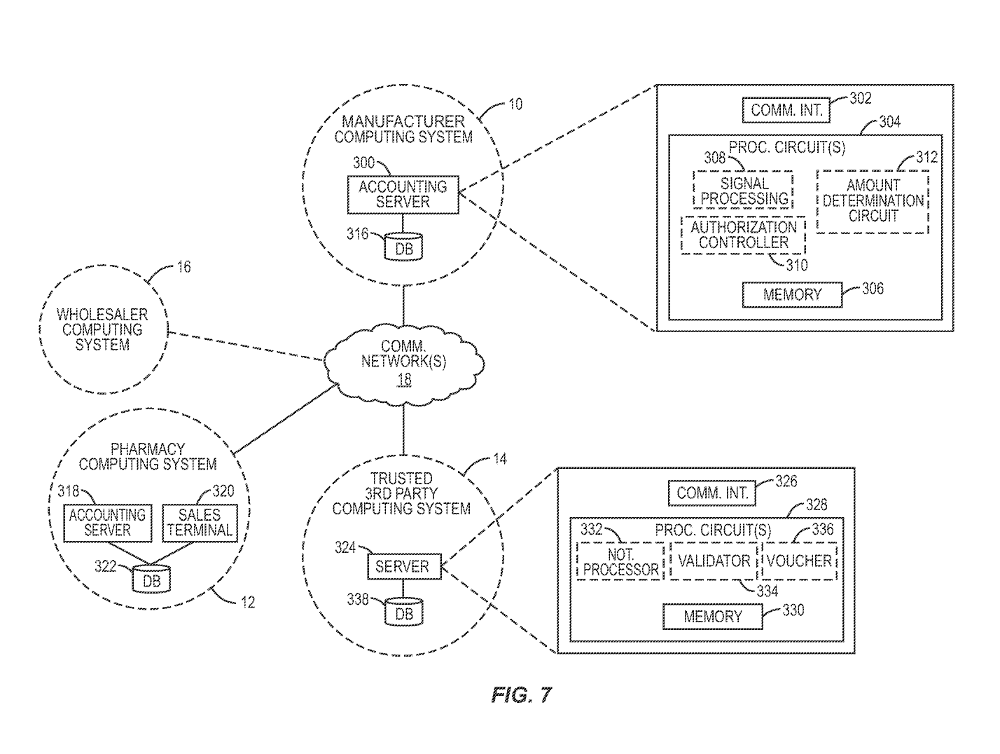

In view of the variations and modifications discussed above, those skilled in the art will appreciate that each of the computing systems herein may generally comprises a system specially configured to execute computer program instructions for carrying out the processes described. Each computing system may thus include any combination of hardware, software, firmware, and the like, and as examples may comprise one or more servers, one or more processing terminals, one or more storage devices, or any other such hardware. FIG. 7 depicts one such example.

As shown in FIG. 7, the pharmacy computing system 12 includes an accounting server 318, a sales terminal 320, and an associated database 322. Likewise, the manufacturer computing system 10 includes an accounting server 300 and an associated database 316. The accounting server 300 comprises one or more communication interfaces 302 and one or more processing circuits 304. The one or more communication interfaces 302 use known signal processing techniques, typically according to one or more communication standards, for communicatively coupling the accounting server 300 to the one or more communication networks 18.

The one or more processing circuits 304 are configured to extract digital data from the one or more interfaces 302 for processing, and to generate digital data for transmission over the one or more interfaces 302. More particularly, the one or more processing circuits 304 comprise one or several microprocessors, digital signal processors, and the like, as well as other digital hardware and memory 306. Memory 306, which may comprise one or several types of memory such as read-only memory (ROM), random-access memory, cache memory, flash memory devices, optical storage devices, etc., stores program code for executing one or more data communications protocols and for carrying out one or more of the techniques described herein. Memory 306 further stores program data, including for example various parameters, for carrying out such techniques and for controlling the operation of the accounting server 300.

Of course, not all of the steps of the techniques described herein are necessarily performed in a single microprocessor or even in a single module. Thus, FIG. 7 presents a generalized view of one or more control circuits configured to carry out the method shown in FIG. 2. These control circuits are pictured in FIG. 7 as a signalling processing circuit 308, an amount determination circuit 312, and an authorization controller 310.

The signalling processing circuit 308 is configured to receive control signalling that indicates the pharmacy has made one or more sales of the prescription pharmaceutical product to one or more patients. This control signalling may be received from the pharmacy's accounting server 318, the pharmacy's sales terminal 320, or from a server of the third-party computing system 14. Regardless, responsive to this determination, the amount determination circuit 312 is configured to determine an amount of one or more future purchases that the pharmacy is to be authorized to make on promotional payment terms, according to one or more rules defining that amount based on at least one of a product quantity and an amount associated with the one or more indicated sales. The authorization controller 310 is configured to then authorize the pharmacy to make one or more future purchases for the determined amount on the promotional payment terms.

Turning now to the third-party computing system 14, the system 14 may include a server 324 and an associated database 338 or other computer-readable storage medium. The server 324 comprises one or more communication interfaces 326 and one or more processing circuits 328. The one or more communication interfaces 326 use known signal processing techniques, typically according to one or more communication standards, for communicatively coupling the server 324 to the one or more communication networks 18.

The one or more processing circuits 328 are generally configured in the same way as described above with respect to the processing circuits 304 of the manufacturer's accounting server, and may include memory 330 that stores program code for carrying out one or more of the techniques described herein. In this regard, FIG. 7 presents a generalized view of one or more control circuits configured to carry out the method shown in FIG. 4. These control circuits are pictured in FIG. 7 as a notification processing circuit 332, a validating circuit 334, and a vouching circuit 336.

The notification processing circuit 332 is configured to receive an electronic notification that indicates the pharmacy has made one or more sales of the prescription pharmaceutical product to one or more patients. The validating circuit 334 is configured to validate that the one or more sales indicated by the notification has actually occurred. And the vouching circuit 336 is configured, responsive to validation of the occurrence of the one or more indicated sales, to vouch for the pharmacy's entitlement to the promotion. More particularly, the vouching circuit 336 is configured to generate control signalling based on the one or more indicated sales for triggering the manufacturer to authorize the pharmacy to make one or more future purchases on promotional payment terms and to send the generated control signalling, via the one or more communication networks 18, to the manufacturer computing system 10.

Those skilled in the art will of course appreciate that FIG. 7 represents just some embodiments of the computing systems herein. In other embodiments, for example, the third-party computing system 14 may be distributed in the sense that a first portion of the system 14 may be physically located at the pharmacy (e.g., as a module, circuit, or computer program on the pharmacy's accounting server 318 or sales terminal 320), while a second portion of the system 14 may be geographically separated from the first portion and connected to the first portion via the one or more communication networks 18.

Those skilled in the art will further appreciate that no particular communication technology is required for communication between the computing systems herein. For example, in some embodiments, the one or more communication networks 18 may include a packet data network, such as the internet, that utilizes the Internet Protocol (IP). But, in general, the one or more communication networks may be any wide area network (WAN), or one or more of any other form of wireless or wireline communication network.

Thus, those skilled in the art will thus recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method for assisting a manufacturer of a prescription pharmaceutical product to promote the product by authorizing a pharmacy that makes one or more sales of the product to make one or more future purchases on promotional payment terms, the method comprising:
receiving one or more electronic notifications at a third-party computing system that indicate the pharmacy has made one or more sales of the prescription pharmaceutical product to one or more patients;
validating at the third-party computing system that the one or more sales indicated by the one or more electronic notifications have actually occurred; and
responsive to said validation, generating control signalling based on the one or more indicated sales for triggering the manufacturer to authorize the pharmacy to make one or more future purchases on promotional payment terms and sending the generated control signalling from the third-party computing system, via one or more communication networks, to a manufacturer computing system associated with the manufacturer.

2. The method of claim 1, wherein said validating comprises extracting from each electronic notification one or more data fields that include information about an indicated sale, retrieving from a computer-readable storage medium one or more rules defining valid entries for those data fields, and validating the one or more data fields against the one or more retrieved rules.

3. The method of claim 1, wherein said receiving comprises receiving the one or more electronic notifications from a computing system associated with a prescription claims processor that processes secondary payment claims for the one or more sales of the product.

4. The method of claim 3, wherein said validating comprises validating that a sale indicated by a received notification has actually occurred if a secondary payment claim for that sale has not been withdrawn within a predetermined period of time.

5. The method of claim 1, further comprising electronically tracking a quantity of the product purchased by the pharmacy, and wherein said validating comprises validating that a quantity of the product sold by the pharmacy, including the one or more indicated sales of the product, is no greater than a quantity threshold defined based on the quantity purchased.

6. The method of claim 5, wherein said electronically tracking comprises receiving sales trace information from the manufacturer that traces sales of the product from the manufacturer into the pharmacy, and wherein said validating comprises reconciling the one or more sales indicated by the one or more electronic notifications against the sales trace information.

7. The method of claim 1, further comprising:
retrieving from a computer-readable storage medium one or more rules defining conditions for one or more sales of a prescription pharmaceutical product to entitle a pharmacy to make one or more future purchases on promotional payment terms;
verifying that the one or more sales indicated by the one or more received notifications meet said conditions; and
selectively performing said generating and sending responsive to said verification.

8. The method of claim 7, wherein said conditions include at least one of:
the pharmacy being included in a defined list of pharmacies eligible for promotional payment terms;
the sold product being included in a defined list of products being promoted with promotional payment terms for one or more future purchases; and
the one or more sales being made within a defined time period.

9. The method of claim 1, wherein said generating comprises generating control signalling that indicates the occurrence of the one or more sales has been validated by the third-party computing system.

10. The method of claim 1, wherein said generating comprises generating control signalling that indicates at least one of:
an amount of the one or more indicated sales made by the pharmacy; and
a quantity of the product sold in connection with the one or more indicated sales.

11. The method of claim 1, wherein an amount of the future purchase that the pharmacy is to be authorized to make on the promotional payment terms is based on either:
an amount of the one or more indicated sales made by the pharmacy;
a quantity of the product sold in connection with the one or more indicated sales and a predefined per-unit value associated with the product.

12. The method of claim 11, further comprising computing said amount and wherein said generating comprises generating control signalling that indicates the computed amount.

13. The method of claim 1, wherein said generating comprises generating control signalling that triggers the manufacturer computing system to authorize the pharmacy, via any wholesaler from which the pharmacy purchased the product, to issue one or more purchase orders according to the promotional payment terms, wherein after receiving a purchase order the manufacturer computing system issues an invoice according to the promotional payment terms.

14. The method of claim 13, further comprising receiving a response from the manufacturer computing system that indicates the manufacturer computing system authorized the pharmacy to issue one or more purchase orders, via said any wholesaler, according to the promotional payment terms, and sending an electronic notification indicating said response to a pharmacy computing system associated with the pharmacy.

15. A trusted third-party computing system configured to assist a manufacturer of a prescription pharmaceutical product to promote that product by authorizing a pharmacy that makes one or more sales of the product to make one or more future purchases on promotional payment terms, the third-party computing system comprising a communication interface to one or more communication networks and one or more processing circuits configured to:
receive one or more electronic notifications at the third-party computing system that indicate the pharmacy has made one or more sales of the prescription pharmaceutical product to one or more patients;
validate at the third-party computing system that the one or more sales indicated by the one or more electronic notifications have actually occurred; and
responsive to said validation, generate control signalling based on the one or more indicated sales for triggering the manufacturer to authorize the pharmacy to make one or more future purchases on promotional payment terms and send the generated control signalling from the third-party computing system, via one or more communication networks, to a manufacturer computing system associated with the manufacturer.

16. The third-party computing system of claim 15, wherein the one or more processing circuits are configured to validate that the one or more sales have actually occurred by extracting from each electronic notification one or more data fields that include information about an indicated sale, retrieving from a computer-readable storage medium one or more rules defining valid entries for those data fields, and validating the one or more data fields against the one or more retrieved rules.

17. The third-party computing system of claim 15, wherein the one or more processing circuits are configured to receive the one or more electronic notifications from a computing system associated with a prescription claims processor that processes secondary payment claims for the one or more sales of the product.

18. The third-party computing system of claim 17, wherein the one or more processing circuits are configured to validate that a sale indicated by a received notification has actually occurred if a secondary payment claim for that sale has not been withdrawn within a predetermined period of time.

19. The third-party computing system of claim 15, wherein the one or more processing circuits are further configured to electronically track a quantity of the product purchased by the pharmacy, and to validate that the one or more indicated sales have actually occurred by validating that a quantity of the product sold by the pharmacy, including the one or more indicated sales of the product, is no greater than the quantity purchased.

20. The third-party computing system of claim 19, wherein the one or more processing circuits are configured to electronically track a quantity of the product purchased by the pharmacy by receiving sales trace information from the manufacturer that traces sales of the product from the manufacturer into the pharmacy, and to validate that the one or more sales have actually occurred by reconciling the one or more sales indicated by the one or more electronic notifications against the sales trace information.

21. The third-party computing system of claim 15, wherein the one or more processing circuits are further configured to:
retrieve from a computer-readable storage medium one or more rules defining conditions for one or more sales of a prescription pharmaceutical product to entitle a pharmacy to make one or more future purchases on promotional payment terms;
verify that the one or more sales indicated by the one or more received notification meet said conditions; and
selectively perform said generating and sending responsive to said verification.

22. The third-party computing system of claim 15, wherein said conditions include at least one of:
the pharmacy being included in a defined list of pharmacies eligible for promotional payment terms;
the sold product being included in a defined list of products being promoted with promotional payment terms for one or more future purchases; and
the one or more sales being made within a defined time period.

23. The third-party computing system of claim 15, wherein the one or more processing circuits are configured to generate control signalling that indicates the occurrence of the one or more sales has been validated by the third-party computing system.

24. The third-party computing system of claim 15, wherein the one or more processing circuits are configured to generate control signalling that indicates at least one of:
an amount of the one or more indicated sales made by the pharmacy; and
a quantity of the product sold in connection with the one or more indicated sales.

25. The third-party computing system of claim 15, wherein an amount of the future purchase that the pharmacy is to be authorized to make on the promotional payment terms is based on either:
an amount of the one or more indicated sales made by the pharmacy;
a quantity of the product sold in connection with the one or more indicated sales and a predefined per-unit value associated with the product.

26. The third-party computing system of claim 25, wherein the one or more processing circuits are configured to compute said amount and to generate the control signalling to indicate the computed amount.

27. The third-party computing system of claim 15, wherein the one or more processing circuits are configured to generate control signalling that triggers the manufacturer computing system to authorize the pharmacy, via any wholesaler from which the pharmacy purchased the product, to issue one or more purchase orders according to the promotional payment terms, wherein after receiving a purchase order the manufacturer computing system issues an invoice according to the promotional payment terms.

28. The third-party computing system of claim 27, wherein the one or more processing circuits are further configured to receive a response from the manufacturer computing system that indicates the manufacturer computing system authorized the pharmacy to issue one or more purchase orders, via said any wholesaler, according to the promotional payment terms, and send an electronic notification indicating said response to a pharmacy computing system associated with the pharmacy.

29. A method for promoting a prescription pharmaceutical product of a manufacturer by authorizing a pharmacy that makes one or more sales of the product to make one or more future purchases on promotional payment terms, the method comprising:
receiving control signalling at a manufacturer computing system associated with the manufacturer that indicates the pharmacy has made one or more sales of the prescription pharmaceutical product to one or more patients;
using the manufacturer computing system, determining an amount of one or more future purchases that the pharmacy is to be authorized to make on promotional payment terms, according to one or more rules defining that amount based on at least one of a product quantity and an amount associated with the one or more indicated sales; and
using the manufacturer computing system, authorizing the pharmacy to make one or more future purchases for the determined amount on the promotional payment terms.

30. The method of claim 29, wherein said authorizing comprises authorizing the pharmacy, via any wholesaler from which the pharmacy purchased the product, to issue one or more purchase orders for the determined amount on the promotional payment terms, and wherein the method further comprises issuing one or more invoices for the determined amount on the promotional payment terms responsive to receiving the one or more purchase orders.

31. The method of claim 29, wherein said authorizing is performed responsive to receiving control signalling indicating that a trusted third-party computing system has validated that the one or more indicated sales have actually occurred.

32. The method of claim 31, further comprising sending control signalling indicating said authorization to the trusted third-party computing system.

33. The method of claim 29, wherein said authorizing comprises authorizing a wholesaler, from which the pharmacy purchased the product, to make one or more future purchases from the manufacturer for the determined amount on the promotional payment terms, wherein the wholesaler in turn authorizes the pharmacy to make one or more future purchases from the wholesaler for the determined amount on the promotional payment terms.

34. A manufacturer computing system associated with a manufacturer of a prescription pharmaceutical product configured to promote that product by authorizing a pharmacy that makes one or more sales of the product to make one or more future purchases on promotional payment terms, the manufacturer computing system comprising a communication interface and one or more processing circuits configured to:
receive control signalling that indicates the pharmacy has made one or more sales of the prescription pharmaceutical product to one or more patients;
determine an amount of one or more future purchases that the pharmacy is to be authorized to make on promotional payment terms, according to one or more rules defining that amount based on at least one of a product quantity and an amount associated with the one or more indicated sales; and
authorize the pharmacy to make one or more future purchases for the determined amount on the promotional payment terms.

35. The manufacturer computing system of claim 34, wherein the one or more processing circuits are configured to authorize the pharmacy, via any wholesaler from which the pharmacy purchased the product, to issue one or more purchase orders for the determined amount on the promotional payment terms, and to issue one or more invoices for the determined amount on the promotional payment terms responsive to receiving the one or more purchase orders.

36. The manufacturer computing system of claim 34, wherein the one or more processing circuits are configured to perform said authorizing responsive to receive control signalling indicating that a trusted third-party computing system has validated that the one or more indicated sales have actually occurred.

37. The manufacturer computing system of claim 36, wherein the one or more processing circuits are further configured to send control signalling indicating said authorization to the trusted third-party computing system.

38. The method of claim manufacturer computing system of claim 34, wherein the one or more processing circuits are configured to authorize the pharmacy by authorizing a wholesaler, from which the pharmacy purchased the product, to make one or more future purchases from the manufacturer for the determined amount on the promotional payment terms, wherein the wholesaler in turn authorizes the pharmacy to make one or more future purchases from the wholesaler for the determined amount on the promotional payment terms.

39. A method implemented by a third party and a computing system associated with a third party for promoting prescription pharmaceutical products of a manufacturer, wherein prescription pharmaceutical products are sold directly or indirectly by the manufacturer to pharmacies, wherein after the sale of the prescription pharmaceutical products by the pharmacies the manufacturer authorizes the pharmacies to make one or more future purchases directly or indirectly from the manufacturer on promotional payment terms, wherein the authorization is conditioned on the sale of the prescription pharmaceutical products, and wherein the promotional payment terms are applied to an amount of the prescription pharmaceutical products that are the subject of the sales, the method comprising:
receiving electronic notifications from various pharmacies at the third party computing station that indicates that certain pharmacies have sold certain amounts of the prescription pharmaceutical products of the manufacturer;
validating at the third party computing station that: (1) the sales have actually occurred and (2) that the sales pertain to prescription pharmaceutical products supplied by the manufacturer;
in response to the third party computing station validating the sales of the prescription pharmaceutical products, sending one or more electronic notifications to the manufacturer which each include data that enable the manufacturer to determine the value to which promotional payment terms should be authorized to a particular pharmacy as a result of the sale validated by the third party computing system; and
wherein the manufacturer in response to receiving the one or more notifications, directly or indirectly authorizes the respective pharmacies to make future purchase on the promotional payment terms based on the data received.
